(19) United States
(12) Patent Application Publication
(10) Pub. No.: US 2026/0249647 A1
(43) Pub. Date: Aug. 27, 2026

(54) WHEEL HUB CLUTCH ACTUATION MECHANISM, WHEEL END DISCONNECT, AND WHEEL END SYSTEM

(71) Applicant: Means Industries, Inc., Saginaw, MI (US)

(72) Inventor: Steven M. Thomas, Saginaw, MI (US)

(21) Appl. No.: 19/100,367

(22) PCT Filed: Jun. 14, 2024
(86) PCT No.: PCT/US2024/033962

§ 371 Date: Jan. 31, 2025

Related U.S. Application Data
(60) Provisional application No. 63/521,045, filed on Jun. 14, 2023.

(51) Int. Cl. B60B 27/04; B60K 17/02; B60K 23/08

(52) U.S. Cl. CPC B60B 27/04; B60K 17/02; B60K 23/08

(57) ABSTRACT

A wheel hub clutch actuation mechanism includes a hub having a rotational axis, a latch member rotatably and axially fixed to the hub, a translating member supported on the latch member, and rotatably fixed and axially movable relative to the rotational axis, an indexer supported on the hub, and rotatably and axially movable relative to the rotational axis, a carrier supported on the hub and engaging the indexer, and rotatably fixed and axially movable for axial motion with no rotation, and a return member biasing the indexer towards a retracted position wherein the translating member acts against the return member to move the indexer to an extended position. The actuation mechanism also may include a manual, pneumatic, or electric actuator to translate the translating member, and may be a bi-stable actuation mechanism. Also disclosed are related wheel end systems including wheel hub clutches actuated by the wheel hub clutch actuation mechanism.

This application claims the benefit of U.S. Provisional Application No. 63/521,045 filed on Jun. 14, 2023, the contents of which is incorporated herein by reference in its entirety.

### TECHNICAL FIELD

This disclosure relates generally to vehicles and, more particularly, to drivetrains of vehicles, axles and wheel end systems of drivetrains, wheel hubs and wheel hub clutches of wheel end systems, and coupling device actuation mechanisms for wheel hub clutches.

### BACKGROUND

Wheeled vehicles include wheels and one or more prime movers, like an internal combustion engine and/or an electric motor, to rotatably drive the wheels. Some such vehicles may drive the wheels directly with an electric motor. Other such vehicles also or instead may include a drivetrain located between the prime mover and the wheels and including an axle to change drive rotation from a longitudinal direction along a length of the vehicle to a transverse direction. The latter vehicles also may include a drive shaft coupled to an input side of the axle and axle shafts extending transversely away from the axle and coupled to the wheels. Some vehicles further may include multiple sets of wheels and multiple axles, usually two rear axles and two sets of wheels driven via the axles. In any case, all such wheels include wheel hubs that couple the wheels (e.g., wheel rim and tire mounted on the rim) to a drivetrain axle shaft or an electric motor shaft. Some wheel hubs include wheel hub clutches configured to disconnect (and reconnect) wheels from a prime mover, for example, to improve fuel economy when a vehicle with multiple driven rear axles is traveling at highway speeds, or to convert a vehicle from four-wheel-drive mode to two-wheel-drive mode. But currently available wheel hub clutches may be too bulky or costly, or of poor quality or reliability. In one specific example, such clutches do not favor remote automatic disconnectability between the prime mover and the wheels, and are located too distant from the wheels such that the clutches are not optimal for driveline efficiency.

### BRIEF SUMMARY

An illustrative embodiment of a wheel hub clutch actuation mechanism includes a hub having a rotational axis, a latch member rotatably and axially fixed to the hub, and a translating member supported on the latch member, and rotatably fixed and axially movable relative to the rotational axis. The mechanism also includes an indexer supported on the hub, and rotatably and axially movable relative to the rotational axis, a carrier supported on the hub and engaging the indexer, and rotatably fixed and axially movable for axial motion with no rotation, and a return member biasing the indexer towards a retracted position wherein the translating member acts against the return member to move the indexer to an extended position.

Another illustrative embodiment of a wheel hub clutch actuation mechanism includes a hub including a shaft, a first member secured to the hub and constrained against rotational and axial movement with respect to the hub, the first member having a side surface extending between an inner and an outer circumferential surface of the first member, the side surface of the first member including a cam surface, and a second member rotatably fixed and axially movable with respect to the first member, the second member having a side surface extending between an inner and an outer circumferential surface of the second member, the side surface of the second member including a cam surface. The mechanism also includes a third member rotatably and axially movable with respect to the shaft, the third member having a side surface extending between an inner circumferential surface and an outer circumferential surface, the side surface of the third member including a first cam surface and a second cam surface, the second cam surface of the third member radially inward of the first cam surface of the third member, the third member having a groove in the inner circumferential surface of the third member. The cam surface of the first member is in the groove of the third member when the mechanism is placed in a retracted position, and the cam surface of the first member contacts the second cam surface of the third member when the mechanism is placed in an extended position.

A further illustrative embodiment of a wheel hub clutch actuation mechanism includes a first member having a cylindrically shaped body, a cam surface extending transversely to a rotational axis of the first member, and an end opposite the cam surface, the first member including a plurality of projections and grooves on an outer circumferential surface of the first member. The mechanism also includes a second member having a cylindrically shaped body, a cam surface extending transversely to a rotational axis of the second member, and a plurality of projections and grooves on an inner circumferential surface of the second member, the projections and grooves on the inner circumferential surface of the second member complementary to the projections and grooves on the outer circumferential surface of the first member wherein engagement of the projections and grooves on the outer circumferential surface of the first member with the projections and grooves on the inner circumferential surface of the second member allows axial movement and prevents rotational movement between the first member in the second member. The cam surface of the second member is spaced radially from and concentric with the cam surface of the first member. The mechanism further includes a third member having a cylindrically shaped body, a cam surface extending transversely to a rotational axis of the third member, and a plurality of projections and grooves on an inner circumferential surface of the third member, the cam surface of the third member including a first cam surface and a second cam surface the first and second cam surfaces are concentric. The first cam surface of the third member engages the cam surface of the second member, and the second cam surface of the third member engages the cam surface of the first member.

### BRIEF DESCRIPTION OF THE DRAWINGS

FIG. 1A is a fragmentary schematic view according to an illustrative embodiment of a wheel end including an embodiment of an integrated electrically operated wheel end disconnect mechanism.

FIG. 1 is a schematic, cross-sectional perspective view of an actuation mechanism for use with a coupling device viewed from the right.

FIG. 2 is a schematic, cross-sectional perspective view of the actuation mechanism of FIG. 1 viewed from the left.

FIG. 3 is a schematic, partially exploded, perspective view of the actuation mechanism of FIG. 1 viewed from the left.

FIG. 3A is an enlarged view of the stop or latch member of the actuation mechanism of FIG. 3.

FIG. 3B is an enlarged view of the translating member of the actuation mechanism of FIG. 3.

FIG. 3C is an enlarged view of the indexer of the actuation mechanism of FIG. 3.

FIG. 4 is a schematic, partially exploded, perspective view of the actuation mechanism of FIG. 1 viewed from the right.

FIG. 4A is an enlarged view of the stop or latch member of the actuation mechanism of FIG. 4.

FIG. 4B is an enlarged view of the translating member of the actuation mechanism of FIG. 4.

FIG. 4C is an enlarged view of the indexer of the actuation mechanism of FIG. 4.

FIG. 5 is a schematic, sectional, perspective view of the actuation mechanism of FIG. 1.

FIG. 6 is a schematic, sectional, perspective view, with portions removed illustrating the actuation mechanism of FIG. 1 in a non-deployed position.

FIG. 7 is a schematic, sectional, perspective view, with portions removed illustrating the actuation mechanism of FIG. 1 moving from a nondeployed position.

FIG. 8 is a schematic, sectional, perspective view, with portions removed illustrating the actuation mechanism of FIG. 1 in a deployed position.

FIG. 9 is a schematic, sectional, perspective view, with portions removed illustrating the actuation mechanism of FIG. 1 moving from a deployed position.

FIG. 10 is a schematic, cross-sectional view of the actuation mechanism for use with a coupling device illustrating stator operation.

FIG. 11 is a schematic view of a pneumatically pressurizable vehicle axle that may be used to actuate a wheel end disconnect mechanism.

FIG. 12 is a fragmentary schematic view according to an illustrative embodiment of a wheel end including an embodiment of an integrated pneumatically operated wheel end disconnect mechanism that may be actuated by the pneumatically pressurizable vehicle axle of FIG. 11.

FIG. 13 is an enlarged fragmentary schematic view according to another illustrative embodiment of a wheel end including another embodiment of an integrated pneumatically operated wheel end disconnect mechanism.

FIG. 14 is a fragmentary schematic view according to another illustrative embodiment of a wheel end including an embodiment of an integrated pneumatically operated wheel end disconnect mechanism that may be actuated by the pneumatically pressurizable vehicle axle of FIG. 11.

FIG. 15 is a fragmentary schematic view according to another illustrative embodiment of a wheel end including an embodiment of an integrated manually operated wheel end disconnect mechanism.

### DETAILED DESCRIPTION

In contrast to complex conventional wheel hub clutches, the present disclosure includes a relatively simple wheel hub clutch configured to allow a wheel hub to be operatively engaged and disengaged from an axle of a driveline of a vehicle. In general, the presently disclosed wheel hub clutch includes an actuation mechanism. The actuation mechanism includes an assembly having a hub, a latch member, a translating member, and an indexer. The assembly also includes a carrier supported on the hub that engages the indexer. The carrier moves axially relative to the hub. A return member biases the indexer to a non-deployed position, with the translating member acting against the return member to move the indexer to the deployed position. More specifically, several example embodiments of the actuation mechanism are described in PCT/US22/52220, filed on Dec. 8, 2022, the contents of which is hereby incorporated herein by reference in its entirety. Additionally, the actuation mechanism may be integrated into a wheel hub to actuate a wheel hub clutch, for example, like that described in PCT/US22/38804, filed on Jul. 29, 2022, the contents of which is hereby incorporated herein by reference in its entirety. The novelty of the wheel hub clutch actuation mechanism and wheel end disconnect lend novelty to a wheel end system, axle, and drivetrain, all including the novel wheel hub clutch.

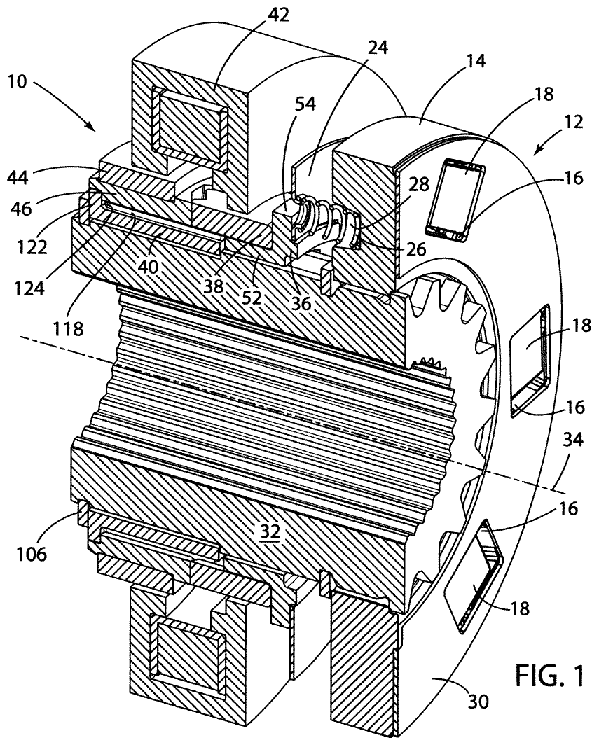

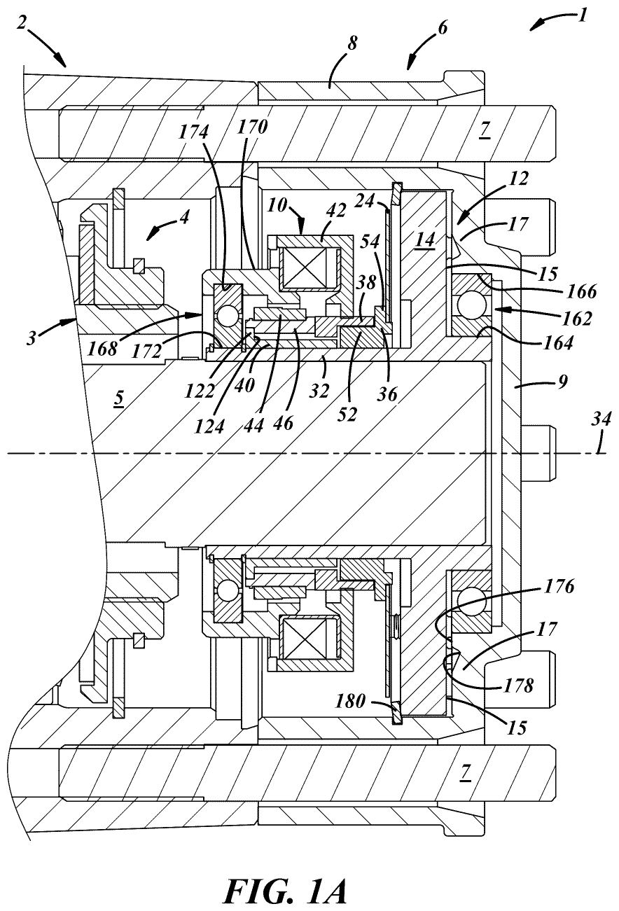

Referring specifically to the drawings, FIG. 1A shows an illustrative embodiment of a wheel end 1 including an embodiment of an integrated electrically operated wheel end disconnect mechanism. The wheel end includes a wheel hub having a wheel hub body 2, a spindle 3 extending through at least a portion of the wheel hub body 2 as is known, a spindle nut system 4 coupled to the spindle 3 as is known, an axle shaft 5 extending through the spindle 3 and beyond an outboard end thereof as is known, a wheel hub cover 6 coupled to the wheel hub body 2 by studs 7 and nuts (not shown) or by bolts (not shown) and having a mounting cylinder portion 8, and a hub cover portion 9. As is known, although not necessarily entirely shown, the wheel hub body 2 has a hub outboard portion with a hub outboard facing surface having fastener passages therein, a spindle passage to accommodate the spindle 3, and a hub flange extending transversely outwardly and having wheel fastener passages extending therethrough to accommodate mounting of a wheel thereto.

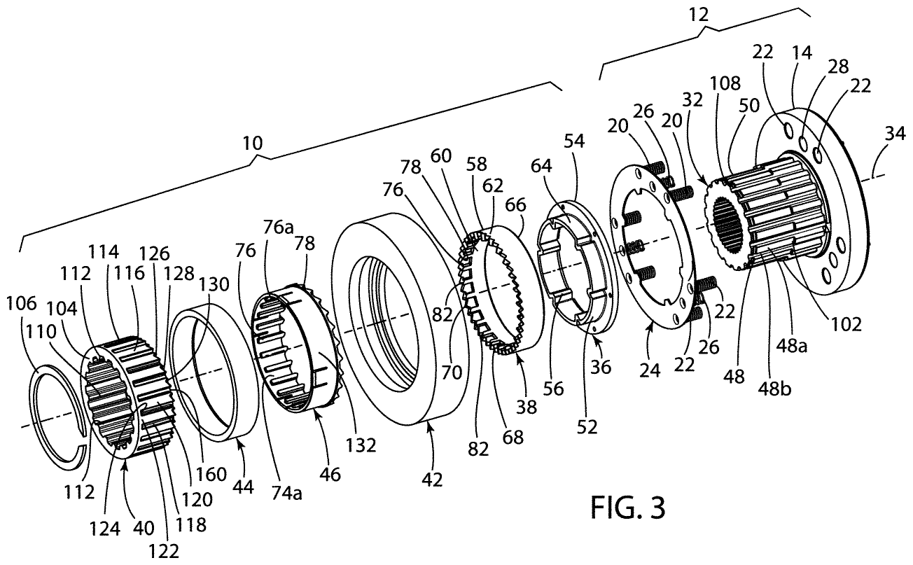

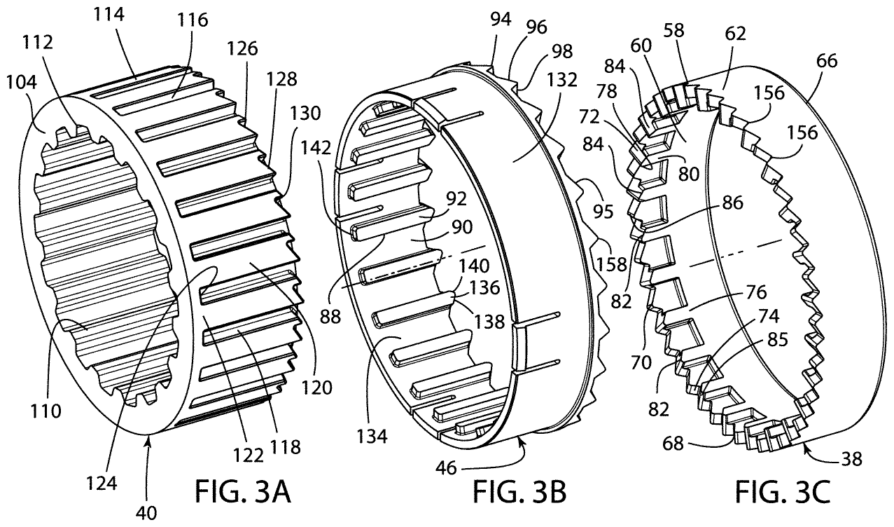

With reference to various FIGS. 1A-4, according to the embodiment of an integrated electrically operated wheel end disconnect mechanism, the wheel end 1 also includes a wheel hub clutch including an actuation mechanism 10 and a coupling device 12. One example of the coupling device 12 is a controllable clutch including an annular member, sometimes referred to as a pocket plate 14, having a plurality of circumferentially spaced recesses or pockets 16 in a face or side surface 15 of the pocket plate 14. As used herein, the term “clutch” should be interpreted to include clutches or brakes wherein one plate is drivably connected to a torque delivery element of a transmission, and the other plate is drivably connected to another torque delivery element or is anchored and held stationary to a housing. The terms “coupling,” “clutch,” and “brake” may be used interchangeably. The coupling device 12 also may include a notch plate 17 that may be unitary with the wheel hub cover 6 as shown, or may be a separate component coupled to the wheel hub cover 6 via splines or the like. More specifically, in the illustrated embodiment, the notch plate 17 is unitary with the hub cover portion 9 of the wheel hub cover 6.

A drive member or biasing member, shown herein as a spring 20, outwardly biases a locking element, shown as a strut 18, pivotally mounted in the recess or pocket 16 in the pocket plate. The biasing member or spring 20 extends through a passage or aperture 22 in the pocket plate 14. One end of the biasing member or spring 20 engages an end of the strut 18, and the opposite end engages a spring plate 24. The actuation mechanism 10 controls the movement of the strut 18. The actuation mechanism 10 moves the spring plate 24 and biasing member or spring 20 linearly toward the pocket plate 14 from a clutch “off” position to a clutch “on” position wherein in the clutch “on” position, the strut 18 moves outwardly past the recess or pocket 16. The clutch “off” position and clutch “on” position may also be referred to as a non-deployed position (clutch “off”) and a deployed position (clutch “on”). For example, the strut 18, located in the pocket plate 14 moves between a between a non-deployed position—the strut 18 located in the pocket 16 and a deployed position—the strut 18 extending outwardly from the pocket 16 and beyond or past the face or side surface 15 of the pocket plate 14.

A return member, shown as a spring 26, extends between a bore 28 in the pocket plate 14 and the spring plate 24. The return member or spring 26 biases the pocket plate 14 and the spring plate 24 apart by moving the spring plate 24 away from the pocket plate 14.

The coupling device 12 may include a cover or selector plate 30 positioned adjacent the face or side surface 15 of the pocket plate 14. The plate 30 may have apertures corresponding to the pockets 16 and aperture edges about which the struts 18 may pivot.

Instead of the drive or biasing member being a coiled spring 20, the spring plate 24 can be operatively connected to other types of strut actuators, such as pins, which linearly move the struts 18 outwardly of the recess or pocket 16 and past the face or side surface 15 of the pocket plate 14.

One example of the actuation mechanism 10 includes an elongated, cylindrical hub 32, extending along and rotating about a longitudinal axis 34, a reaction member or carrier 36 (e.g., spring plate carrier), an indexer 38, a stop or latch member 40, a stator 42, a translator 44, and a translating member 46. Depending upon the relative positions of the indexer 38 and stop or latch member 40, the actuation mechanism 10 moves between an initial or retracted position and a subsequent or extended position. The return member or spring 26 operates to bias or urge the actuation mechanism 10 to the initial or retracted position. The stator 42 may include at least one electromagnetic source, for example, an electromagnet including electromagnetically inductive coils carried between fingers of a ferromagnetic housing. In other embodiments, the electromagnetic source may include any suitable structure to produce a magnetic field suitable for use with a wheel hub clutch.

The hub 32 includes a plurality of elongated splines 48 extending longitudinally along an outer circumferential surface 50 of the hub 32. The splines 48 are a plurality of radially extending projections 48a, external splines, separated by grooves 48b, internal splines, formed longitudinally around the outer circumferential surface 50 of the hub 32. The splines 48 fit into corresponding grooves, internal splines, and projections, external splines in a mating part.

The carrier 36 includes a cylindrical body 52 and a radially outwardly extending flange 54. The cylindrical body 52 of the carrier 36 has radially inwardly extending splines 56. The splines 56 mate with the grooves 48b of the splines 48 on the outer circumferential surface 50 of the hub 32. The cylindrical body 52 is positioned and sliding longitudinally on the outer circumferential surface 50 of the hub 32. The corresponding splines 48, 56 prevent relative rotation between the carrier 36 and the hub 32. The splined connection between the carrier 36 and hub 32 permits reciprocal axial movement of the carrier 36 along the hub 32 in the direction of the longitudinal axis 34. The radially outwardly extending flange 54 of the carrier 36 engages the spring plate 24, wherein longitudinal movement of the carrier 36 correspondingly moves the spring plate 24. In an alternative embodiment, the spring plate 24 and the carrier 36 can be an integral or unitary member.

The indexer 38 has a cylindrical body 58 having an inner circumferential surface 60 and an outer circumferential surface 62. The cylindrical body 58 of the indexer 38 is positioned over the cylindrical body 52 of the carrier 36; specifically, the inner circumferential surface 60 of the cylindrical body 58 of the indexer 38 is located adjacent to an outer circumferential surface 64 of the cylindrical body 52 of the carrier 36. One end 66 of the indexer 38 engages the radially outwardly extending flange 54 of the carrier 36. The opposite end 68 of the indexer 38 includes a plurality of longitudinally extending first or outer cam members 70 disposed circumferentially about the opposite end 68 in a saw-tooth configuration—each outer cam member 70 having a cam surface or ramp 72 and a cam displacement surface 74. The first or outer cam members 70 are adjacent to the outer circumferential surface 62 of the indexer 38. The indexer 38 moves through incremental positions and cooperates with other components of the actuation mechanism 10 to locate or place the actuation mechanism in either an “on” or “off” position.

The inner circumferential surface 60 of the indexer 38 includes a plurality of splines 76 formed of longitudinally extending grooves/guides 78 and projections or fingers 80. The projections or fingers 80 extending to the end 68 of the indexer 38. The projections or fingers 80 forming second or inner longitudinally extending cam members 82 disposed circumferentially about the opposite end 68. The second cam members 82 are adjacent to the inner circumferential surface 60 of the indexer 38. Each finger 80 includes a cam surface or ramp 84, extending at the same angle and in common with the cam surface or ramp 72 of the outer cam members 70. The groove or guide 78 terminates or ends the cam surface or ramp 84 of the projection or finger 80 before the cam surface or ramp 84 reaches the vertex 86 of a first or outer cam member 70, the vertex being the intersection of the cam surface or ramp 72 and the cam displacement surface 74.

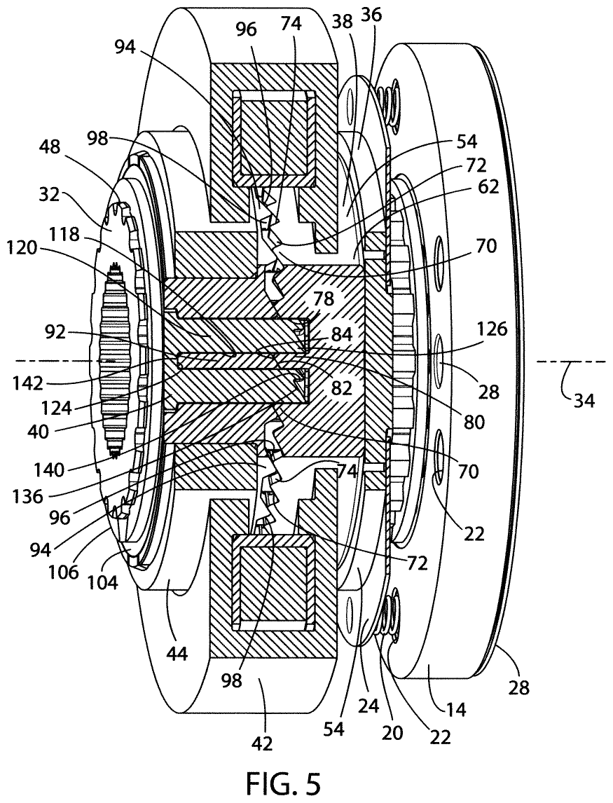

The indexer 38 rotates about the hub 32 and the carrier 36 and slides axially to both. As shown in FIGS. 5-9, the indexer 38 rotates circumferentially in the direction of the arrow 152. The indexer 38 also moves reciprocally, in an axial direction, in the direction of arrows 150, 160, along the longitudinal axis 34 of the hub 32 of the actuator mechanism 10.

The translating member 46 includes a plurality of longitudinally extending first or outer cam members 94 disposed circumferentially about one end 95 of the translating member 46 in a saw-tooth configuration—each cam member 94 having a cam surface or ramp 96 and a cam displacement surface 98. The first or outer cam members 94 are adjacent to the outer circumferential surface 132 of the translating member 46.

An inner circumferential surface 134 of the translating member 46 includes a plurality of splines 88 formed of longitudinally extending grooves or guides 90 and projections or fingers 92. The projections or fingers 92 extend longitudinally from the end 95 of the translating member 46. The ends of the projections or fingers 92 form second or inner cam members 136, which are adjacent to the first or outer cam members 94. The second or inner cam members 136 include cam surfaces or ramps 138 and cam displacement surfaces 140. Similar to the respective cam surfaces or ramps 72, 84 of the outer and inner cam members 70, 82, the respective cam surfaces or ramps 138 of the inner cam members 136 of the translating member 46 extend at the same angle and in common with the cam surface or ramps 96 of the first or outer cam members 94.

While at the same angle and in common, the respective cam surfaces or ramps of both sets of cam members 70, 82 and 94, 136 could have different angles and lie at different circumferential positions, for example, spaced apart.

The first or outer members 94, and corresponding cam surfaces or ramps 96 and cam displacement surfaces 98, of the translating member 46 cooperate and work with the corresponding or complementary first or outer cam members 70, and corresponding cam surfaces or ramps 72 and cam displacement surfaces 74, of the indexer 38. While the second or inner cam members 136, and corresponding cam surfaces or ramps 138 and cam displacement surfaces 140, of the translating member 46 cooperate and work with the corresponding or complementary second or inner cam members 82, and corresponding cam surfaces or ramps 84 and cam displacement surfaces 85, of the indexer 38.

The stop or latch member 40 is fixed to the hub 32. As shown in FIG. 1, a longitudinal end 100 of the stop or latch member 40 engages a shoulder 102 on the hub 32. The opposite longitudinal end 104 of the stop or latch member 40 is held stationary on the hub 32 by a snap ring 106 in a circumferential groove 108 in the hub 32. An inner circumferential surface 110 of the stop or latch member 40 includes splines 112 engaging the splines 48 of the hub 32 to prevent rotation of the stop or latch member 40 with respect to the hub 32. An outer circumferential surface 114 of the stop or latch member 40 includes a plurality of longitudinally extending splines 116 formed of longitudinally extending grooves or guides 118 and projections or fingers 120. The end 104, adjacent to the snap ring 106, has an annular portion 122 forming an end wall or surface 124 of the grooves or guides 118.

The stop or latch member 40 includes a plurality of longitudinally extending cam members 126 disposed circumferentially at the ends of the projections or fingers 120 near the end 100 of the stop or latch member 40 contacting the shoulder 102 of the hub 32. Each cam member 126 of the stop or latch member 40 includes a cam surface or ramp 128 and a cam displacement surface 130. The cam members 126 have a saw-tooth configuration.

The cam surface or ramp 128 is complementary to and has the same angle as the cam surface or ramp 84 of the second cam 82 of the indexer 38. The cam displacement surface 130 is complementary to and has the same angle as the cam displacement surface 85 of the indexer 38.

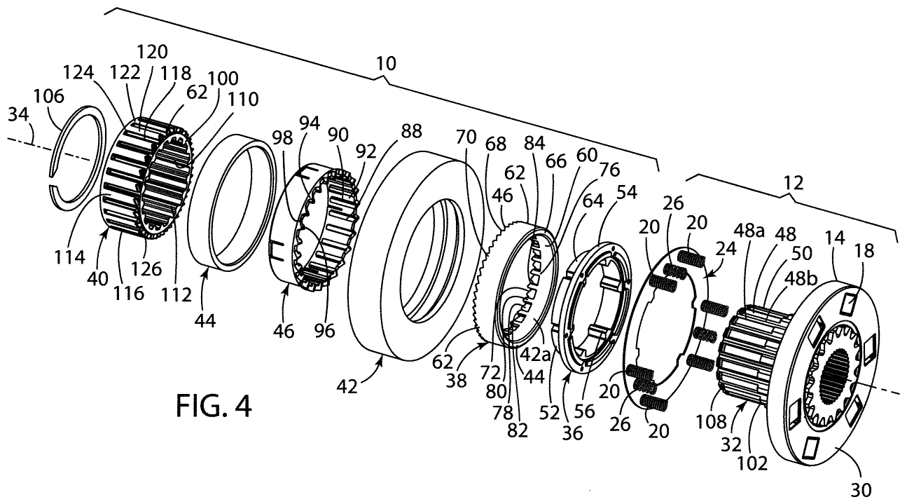

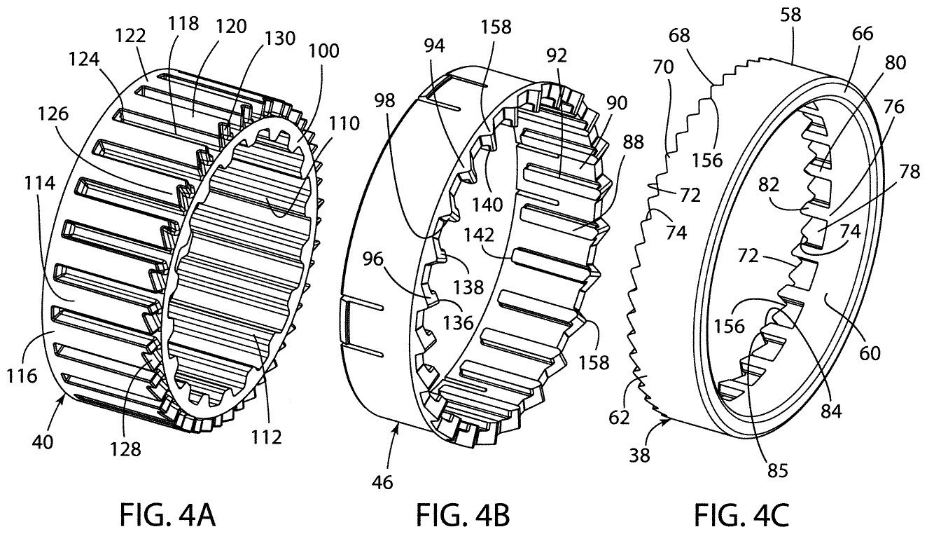

The grooves or guides 118 on the outer circumferential surface 114 of the stop or latch member 40 have the same circumferential width as the circumferential width of each longitudinally extending projection or finger 80 of the indexer 38. As illustrated in FIG. 4, the longitudinally extending projections or fingers 80 of the indexer 38 slide axially in the grooves or guides 118 of the stop or latch member 40.

As also illustrated in FIG. 4, the coupling device 12 includes two active sets of struts 18 configured to be advanced simultaneously, such that the coupling device may operate according to an unlocked/disengaged or bidirectionally uncoupled mode (0/0), and a locked/engaged or bidirectionally coupled mode (1/1). One set of the struts 18 is oriented in a clockwise facing direction and another set of the struts is oriented in a counterclockwise facing direction. In other embodiments, the coupling device 12 may include only one set of the struts 18, either a clockwise facing set or a counterclockwise facing set, depending on desired functionality. In yet another embodiment, the coupling device 12 may include one of the sets of struts 18 being a passive set of struts configured to be persistently biased toward an engaged position by a strut spring (not shown), such that the coupling device 12 operates according to a one-way mode (1/0 or 0/1) depending on CW or CCW configuration.

In addition to cooperating with the inner cam members 136 of the translating member 46, the second or inner cam members 82 of the indexer 38 also cooperate with the cam members 126 of the stop or latch member 40.

The stator 42 provides a magnetic field that acts on the translator 44, in the present example, a steel ring. Electric current applied to the stator 42 creates a magnetic field that acts on and moves the translator 44. Because the translator 44 is attached to the translating member 46, secured to the outer circumferential surface 132 thereof, movement of the translator 44, caused by the stator 42, results in movement of the translator 44 and translating member 46 combination. The projections or fingers 92 on the circumferential surface 132 of the translating member 46 engage the grooves or guides 118 of the stop or latch member 40. The translating member 46 and translator 44 move axially along the stop or latch member 40 in the direction of the longitudinal axis 34 but do not rotate about the stop or latch member 40. The translatory or sliding motion of the translating member 46 on the stop or latch member 40 is similar to that of a plunger moving back and forth in a reciprocal motion.

As the translating member 46 moves longitudinally in the direction of the longitudinal axis 34, the cam surfaces or ramps 96 and cam displacement surfaces 98 of the cam members 94 of the translating member 46 interact with corresponding cam surfaces or ramps 72 and cam displacement surfaces 74 of the outer cam members 70 of the indexer 38 to both axially move and rotate the indexer 38.

The actuation mechanism 10 moves the coupling device 12 between an “off” position and an “on” position. In the “on” position, the actuation mechanism 10 extends and moves the carrier 36 and spring plate 24 combination closer to the pocket plate 14, wherein the springs 20 act on the struts 18. In the “off” position, the actuation mechanism 10 retracts, moves to the initial position, enabling the carrier 36 and spring plate 24 combination to be spaced further from the pocket plate 14. The “on” and “off” positions of the coupling device 12 can be established by the location of, or the relative engagement of, the indexer 38 and the stop or latch member 40.

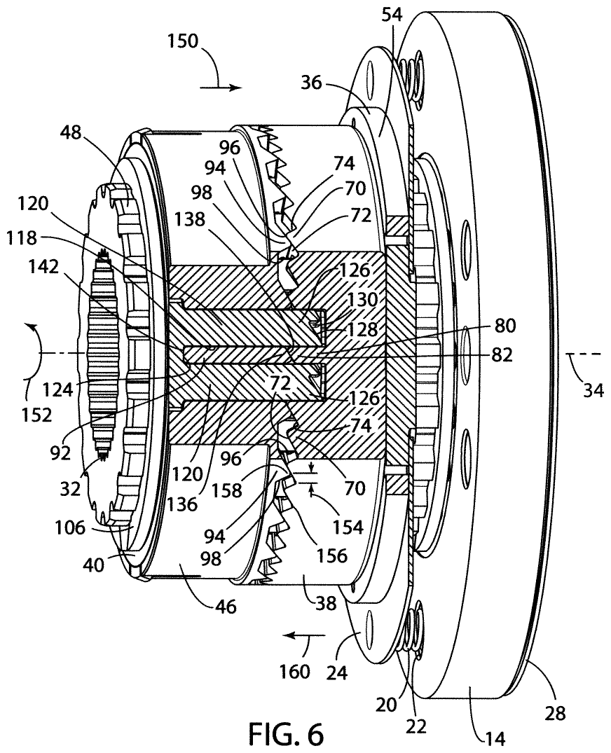

FIGS. 5-6 illustrate the actuation mechanism 10 in a retracted position placing the coupling device 12 in the “off” position, with the stator 42 and translator 44 removed for clarity in FIGS. 6-9. The retracted position occurs when the cam surface or ramp 84 and projection or finger 80 of the indexer 38 are positioned in the grooves or guides 118 of the stop or latch member 40, with the projections or fingers 120 and corresponding cam members 126 of the stop or latch member 40 positioned in the grooves or guides 78 of the indexer 38 wherein the cam surface or ramp 84 of the projection or finger 80 contacts the cam surface or ramp 138 of the projection or finger 92 of the translating member 46. The force applied by the return members or springs 26 maintains engagement between the cam surface or ramp 84 of the projection or finger 80 of the indexer 38 and the cam surface or ramp 138 of the projection or finger 92 of the translating member 46, wherein the end 142 of the projection or finger 92 of the translating member 46 contacts and rests on the end wall or surface 124 of the groove or guide 118 of the stop or latch member 40.

The cam surface or ramp 72 of the first or outer cam member 70 of the indexer 38 contacts the cam surface or ramp 96 of an adjacent first or outer cam member 94 of the translating member 46. The respective cam surfaces or ramps 72, 96 are shown contacting one another approximately midway along the respective cam surfaces or ramps 72, 96. Because the stator 42 is not engaged, the first or outer cam members 94 of the translating member 46 apply no force to the indexer 38. Depending upon tolerances or design, there may be a slight gap or space between the respective cam surfaces or ramps 72, 96 when the stator 42 is off. When the stator 42 is off, the translating member 46, particularly the projection or finger 92, transfers the load from the carrier 36 through the indexer 38 to the stop or latch member 40. When the stator 42 is actuated, the translating member 46 applies force to the indexer 38 to move the indexer 38 axially, in the direction of the arrow 150, toward the pocket plate 14, enabling it to, due to interaction with the translating member 46 and the stop or latch member 40, rotate and position the coupling device 12 in one of the “on” or “off” positions.

Actuation of the stator 42 pulls the translating member 46 and translator 44 combination toward the stator 42 using electromagnetics. Pulling the translating member 46 and translator 44 combination toward the stator 42 moves the translating member 46 and translator 44 combination axially, in the direction of the arrow 150. The engagement configuration between the first or outer cam members 70 of the indexer 38 and the first or outer cam members 94 of the translating member 46 stays, as shown in FIG. 5, until the projections or fingers 80 and corresponding second or inner cam members 82, including the cam surfaces or ramps 84, pushed axially in the direction of the arrow 150 by the projections or fingers 92 of the translating member 46, clear the grooves or guides 118 between adjacent projections or fingers 120 of the stop or latch member 40.

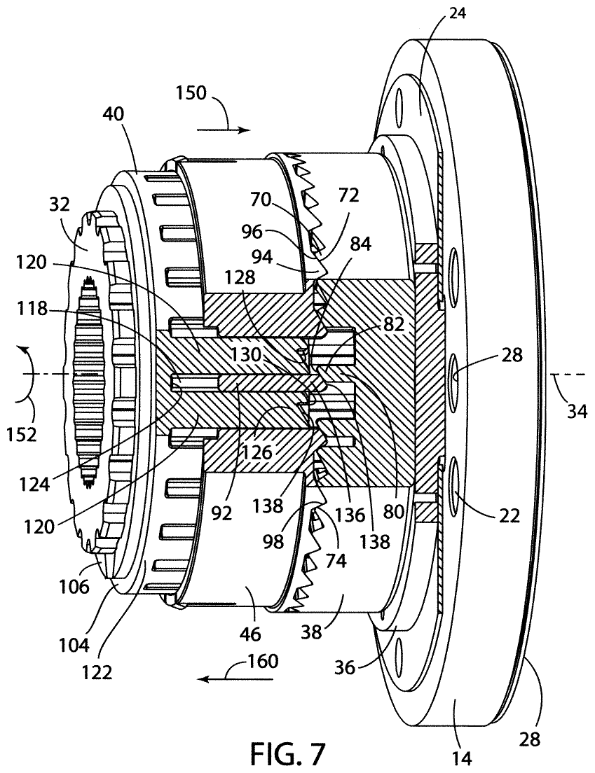

FIG. 7 shows, once the projections or fingers 80 of the indexer 38 clear the grooves or guides 118 of the stop or latch member 40 the force applied by the return member or spring 26 acts, through the carrier 36, on the indexer 38 and correspondingly the adjacent cam surfaces or ramps 72, 96 of the indexer 38 and the translating member 46. The force, through the cam surface or ramps 72, 96, of the first or outer cam member 70 of the indexer 38 and adjacent first or outer cam member 94 of the translating member 46, rotates the indexer 38 in the direction shown by arrow 152. As the indexer 38 rotates to the position in FIG. 7, the cam surface or ramp 72 of the first or outer cam member 70 of the indexer 38 slides along the respective cam surface or ramp 96 of the first or outer cam member 94 of the translating member 46 until the cam displacement surfaces 74, 98 of the outer cam members 70, 94 engage or contact one another. Engagement of cam displacement surfaces 74, 98 stops rotation, movement in the direction of the arrow 152, of the indexer 38. The amount or degree of rotation is determined by the circumferential gap or space 154 between the apex 156 of first or outer cam member 70 of the indexer 38 and the vertex 158 of first or outer cam member 94 of the translating member 46. The indexer 38 rotates due to the axial force applied by the stator 42 to the translator 44 and translating member 46 acting against the return member or spring 26 and on the cam surfaces or ramps 72, 96. The cam surfaces or ramps 84, 138 of the second or inner cam members 82, 136 form complementary ramp surfaces on which the cam members 82, 136 slide. FIG. 7 shows the rotation of the indexer 38 stopped with the projection or finger 80 and corresponding cam surface or ramp 84 of the second or inner cam member 82 positioned slightly over, or above, the cam surface or ramp 138 of the projection or finger 92 of the second or inner cam member 136 of the translating member 46.

De-energizing the stator 42 removes the axial force applied by translator 44 on the translating member 46. FIG. 6 shows moving the translator 44 and the translating member 46 in the direction shown by the arrow 160, disengages the indexer 38 and translating member 46, wherein the outer cams 70, 94 separate from one another. The force provided by the return member or spring 26 slides the cam surface or ramp 84 of the second or inner cam 82 of the indexer 38 along the angled cam surface or ramp 128 of the cam member 126, rotating the indexer 38 in the direction of the arrow 152. The translating size, axial amount, or degree of the circumferential gap or space 154 between the indexer 38 and translating member 46 is shown for illustrative purposes only and may vary. The respective cam displacement surfaces 74, 85 are angled or inclined with respect to the longitudinal axis 34. As the indexer 38 rotates and moves, in the direction of the arrow 152, the angled or inclined cam displacement surface 74 acts on the corresponding angled or inclined cam displacement surface 98 to help move and allow movement of the translating member 46 in the direction of the arrow 160, away from the indexer 38.

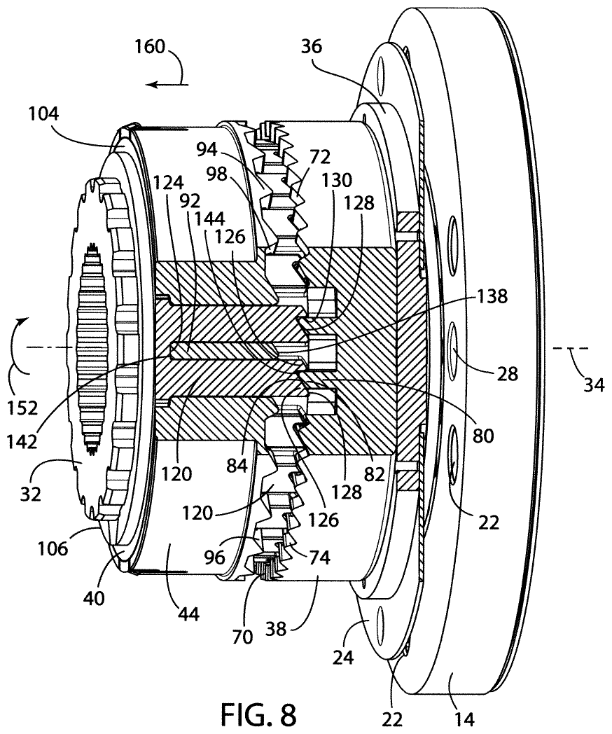

The return member or spring 26 also moves the indexer 38 axially in the direction shown by arrow 160, wherein the cam surface or ramp 84 of the projection or finger 80 engages a corresponding angled cam surface or ramp 128 of the cam member 126 of the stop or latch member 40. Engagement of the cam surface or ramp 84 and the corresponding angled cam surface or ramp 128 rotates the indexer 38 in the direction of the arrow 152. Once again, the indexer 38 rotates in the direction of the arrow 152 due to the axial force applied by the return member or spring 26 and the angled cam surfaces or ramps 84, 128. Sliding or relative movement between the adjacent cam surfaces or ramps 84, 128 rotates the indexer 38 about the longitudinal axis 34 in the direction of arrow 152. As shown in FIG. 8, the projection or finger 80 of the indexer 38 now rests in the shallow notch 144 between adjacent cam surfaces or ramps 128 and cam displacement surfaces 130 placing the clutch in the “on” position.

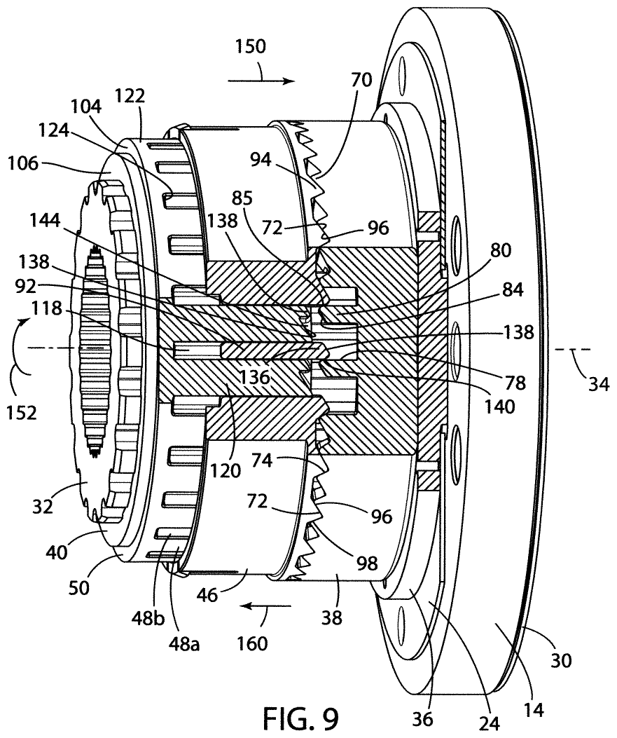

Moving the clutch from the “on” position to the “off” position requires re-energizing the stator 42. Upon energizing the stator 42, the translator 44 and translating member 46 combination moves axially in the direction of arrow 150. The cam surfaces or ramps 72, 96 again engage one another. The translating member 46 acts against the return member or spring 26, moves the indexer 38 axially, and lifts the corresponding projections or fingers 80 of the indexer 38 out of the notch 144 formed between adjacent cam surfaces or ramps 128. Once the projections or fingers 80 are clear of the notch 144, the indexer 38 rotates in the direction of the arrow 152 until the cam displacement surface 85 of the second or inner cam member 82 of the translating member 46 engages the cam displacement surface 140 of the second or inner cam member 136 of the translating member 46, the respective sides of adjacent projections or fingers 80, 92 engage one another; see FIG. 9. In addition, the respective cam displacement surfaces 74, 98 engage one another. The cam surface or ramp 84 is positioned over the cam surface or ramp 128 adjacent to the groove or guide 118 in the stop or latch member 40. FIG. 9 shows the indexer 38 rotating approximately 3-5°to align the adjacent cam surfaces or ramps 84, 128. When the stator 42 is deenergized, the return member or spring 26 moves the indexer 38 in the direction of the arrow 160, wherein the cam surface or ramp 84 slides on the cam surface or ramp 128 and rotates the indexer 38 in the direction of the arrow 152. The rotation causes inclined or angled cam displacement surface 74 to slide up and over correspondingly inclined or angled cam displacement surface 98. Indexer 38 rotation continues until the projections or fingers 80 of the indexer 38 enter and slide in the grooves or guides 118—locating the projections or fingers 80 in the grooves/guides 118 places the actuation mechanism 10 and correspondingly the clutch in the “off” position, as illustrated in FIG. 6.

The rotation or amount of rotation of the indexer 38 is determined by the angle of the ramps or cam surfaces 72, 74, 84, 85, 96, 98, 138, 140, 128, and 130. Continued rotation of the indexer 38 continues the extend/retract cycle by repeating the same steps.

The foregoing disclosure incorporates using a plurality of different cams and indexers rotating about a longitudinal axis of a clutch shaft.

The forgoing provides an actuation mechanism requiring zero power while in state and in one direction of actuation regardless of traveling from “on” to “off” or “off” to “on.” The forgoing works well in situations where the parts rotate-centrifugally neutral.

With reference again to FIG. 1A, the pocket plate 14 may be coupled to the axle shaft 5 and supported in any suitable manner. In the illustrated embodiment, the pocket plate 14 is provided in the form of a disc or flange extending radially outwardly from the cylindrical hub 32 that is splined to the axle shaft 5 such that the pocket plate 14 and the cylindrical hub 32 are unitary. In other embodiments, the cylindrical hub 32 may be splined to the axle shaft 5 and, in turn, the pocket plate 14 may be a separate component splined to the cylindrical hub 32. The cylindrical hub 32 may be supported by an outboard bearing 162 interposed between the cylindrical hub 32 and the wheel hub cover 6. More specifically, the outboard bearing 162 may be carried on an outboard external journal 164 of the cylindrical hub 32 and an internal journal 166 of the wheel hub cover 6 at a location axially outboard of the pocket plate 14. Also, the cylindrical hub 32 may be supported by an inboard bearing 168 interposed between the cylindrical hub 32 and a stator support or actuator support 170. More specifically, the inboard bearing 168 may be carried on an inboard external journal 172 of the cylindrical hub 32 and an internal journal 174 of the actuator support 170 at a location axially inboard of the pocket plate 14. To facilitate assembly, the inboard external journal 172 of the cylindrical hub 32 may be part of a separate component that splines to the rest of the cylindrical hub 32.

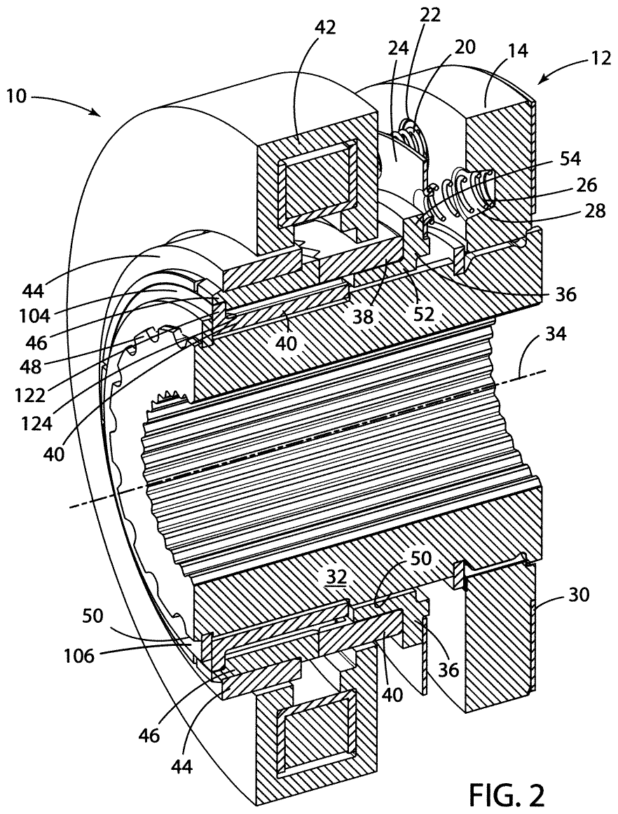

The coupling device includes a first coupling member that may be in the form of the notch plate 17 selectively rotatable about the rotational axis 34, a second coupling member that may be in the form of the pocket plate 14 rotatable about the rotational axis 34, and a plurality of locking members that may be in the form of the struts 18 (FIG. 1) to transmit torque between the first and second coupling members. The notch plate 1 may include a first face 176 having a plurality of locking features, for example, notches 178. The pocket plate 14 may be axially retained with respect to the notch plate 17, for example, via a snap ring 180 that may be coupled to the cylindrical mounting portion 8 of the wheel end cover 6, and may include a second face in the form of the side surface 15 in opposition to the first face 176 of the notch plate 17 and having the plurality of pockets 16 (FIG. 1), and a third face 182 spaced from the second face or side surface 15 and having the plurality of passages 22 (FIG. 2) in communication with the plurality of pockets 16 (FIG. 1). The struts 18 (FIG. 1) may be T-shaped struts or of any other shape and/or configuration suitable for use with the other components.

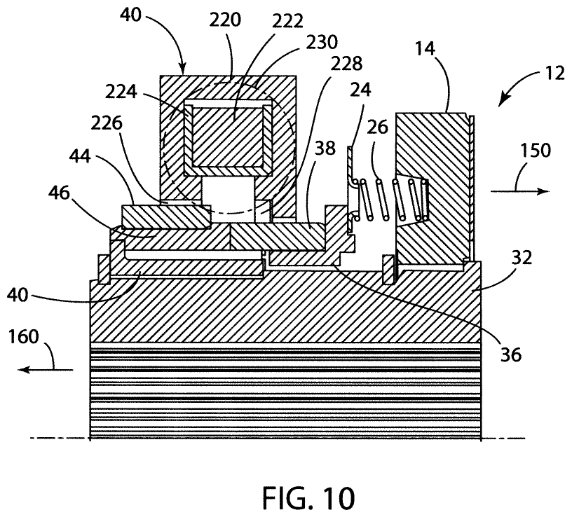

FIG. 10 illustrates the stator 42 and translator 44 of the actuation mechanism 10. The stator 42 is stationary and is fixed to the stationary member, for example a transmission case (not shown). The stator 42 having a housing 220 and an electromagnetically inductive coil 222 positioned between adjacent ferromagnetic fingers 224. The electromagnetically inductive coil 222 creates a magnetic flux when energized.

The translator 44, coupled to the translating member 46, is mounted for rotational and axial movement on the hub 32. The translator 44 is radially spaced from the stator 42, with a radial gap 226 and an axial gap 228 between the stator 42 and translator 44. The gaps 226, 228 are sized such that the translator 44 is spaced from and does not contact the stator 42. Both gaps 226, 228 provided for tolerance differences between the respective stator and translator while maintaining a spacing between them. In one example the gap is in the order of point-blank millimeters. The smaller the gap, the less current needed to move the translator 44 and corresponding translating member 46.

The magnetic flux lines 230, flow along closed paths with the majority of lines extending in a circular path across the radial gap 226 between the stator 42 and translator 44. The flow of the flux lines produced by the stator 42 result in a net force on the translator 44. The magnetic flux lines cross the gap 226, 228 wherein the electromagnetically inductive coil 222 and the coil current drives the translator 44 in the direction of the arrow 150.

The electromagnetic source or electromagnetically inductive coil 222 creates an electronically switched magnetic field across the radial and axial gaps 226, 228 that acts on the translator 44 causing translational movement of the translator 44 and corresponding translating member 46 relative to the stator 42 along the longitudinal axis 34 in the direction of the arrow 150.

The stator 42 provides a pulse actuator, wherein energizing, supplying an electrical current to, the electromagnetically inductive coil 222 creates the magnetic field and moves the translator 44. Deenergizing, removing or turning off the electrical current to, the electromagnetically inductive coil 222 removes the magnetic field and correspondingly allows the return spring 26 to act on the indexer 38 and corresponding translator member 46 moving them rearwardly, in the direction of the arrow 160.

The stator 42 operates as a pulse actuator, the electrical current supplied to the electromagnetically inductive coil 222 may be supplied as a pulse, the duration and degree of which supplied in an amount to move the translator 44, translating member 46 and indexer 38 to a position wherein the fingers 80 of the indexer 38 clear the guides 118 of the latch member 40 as shown in FIG. 7. Once the fingers 80 are clear, the electric current to the electromagnetically inductive coil 222 turned off wherein the return springs 26 act on the indexer 38 moving both the indexer and the translating member 46 in the direction of the arrow 160.

The stator 42 and translator 44 cooperate to move, pull the translating member 46 to the right, in the direction of the arrow 150, to both mechanically latch and mechanically unlatch the actuation mechanism 10, and place the coupling device 12 in a deployed and non-deployed position.

The actuation mechanism 10 provides a two-position latch, a first, retracted position, and a second, extended position. In the first, retracted position the second or inner set of cam members 82 of the indexer 38 are in grooves or guides 118 of the stop or latch member 40. In one example, the second or inner set of cam members 82 engage a second or inner set of cam members 136 of the translating member 46. In the second position, the second or inner set of cam members 82 engage the cam members 126 of the stop or latch member 40. In the first and second positions, the stop or latch member 40 provides positive support; i.e., force applied to the indexer 38 in the direction of the arrow 160 is supported by the stop or latch member 40. The stop or latch member 40 provides a fixed, hard stop or hard lock limiting axial movement of the indexer 38.

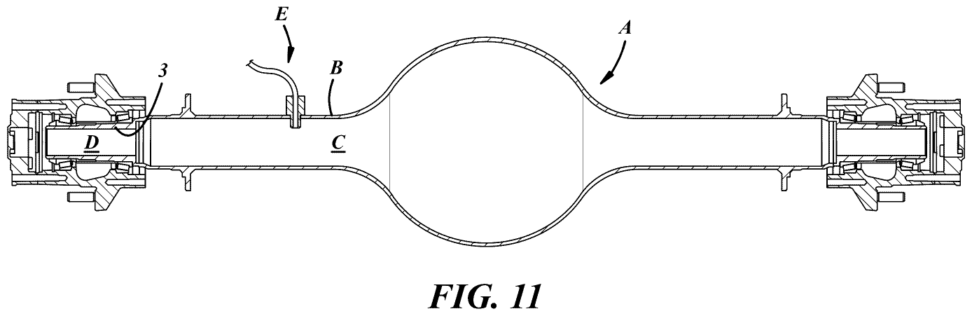

FIGS. 11 through 15 illustrate several additional illustrative embodiments of wheel ends, wheel end disconnect mechanisms, wheel hub clutches, wheel hub clutch actuation mechanisms, wheel hub clutch coupling devices, and components and features therefor. These embodiments are similar in many respects to the embodiments of FIGS. 1-10 and to one another and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

FIG. 11 shows an illustrative embodiment of a pneumatically pressurizable vehicle axle A that may be used to actuate a wheel end disconnect mechanism. The axle A may include a hollow housing B having an interior C in communication with an interior D of the spindle 3 and may be pressurized by an pneumatic line E that may be supplied with pressurized gas from any suitable source (not shown). For example, commercial trucks use compressed air to actuate air brakes and a similar supply of compressed air can be used or the same supply as that used to actuate air brakes. Although not separately shown, a pneumatic control valve, controller, and the like may be used to pressurize the axle interior C to activate the wheel end disconnect mechanism as desired.

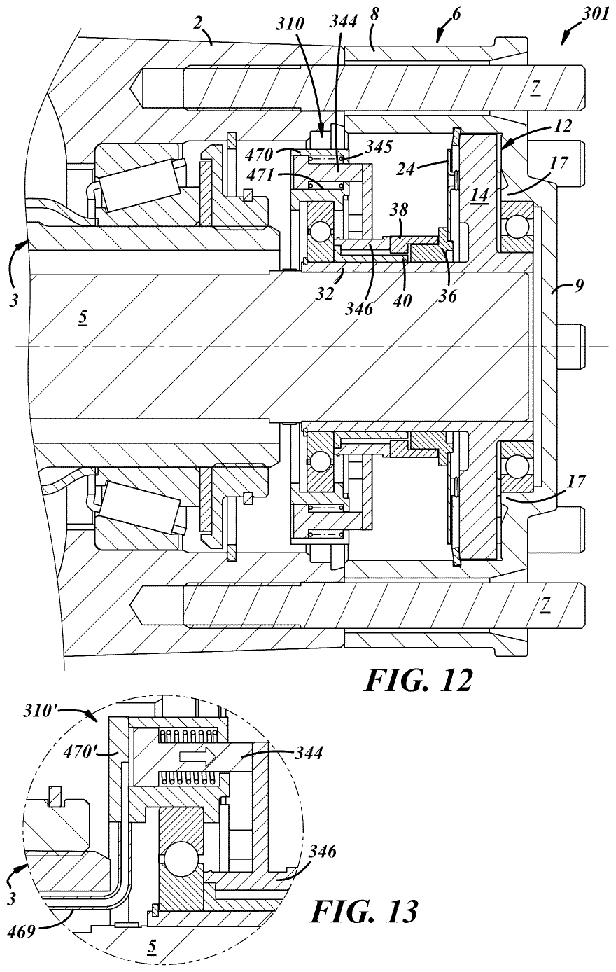

FIG. 12 shows another illustrative embodiment of a wheel end 301 including an embodiment of an integrated pneumatically operated wheel end disconnect mechanism. The wheel end 301 includes the axle shaft 5, the coupling device 12 including the pocket plate 14 coupled to the axle shaft 5 and the notch plate 17 integrated into the wheel hub cover 6, and an actuation mechanism 310 including the elongated, cylindrical hub 32, the carrier 36, the indexer 38, the stop or latch member 40, a translator 344, and a translating member 346. The translator 344 may be part of a pneumatic actuator to move the translating member 346. The pneumatic actuator may include the translator 344 in the form of a plurality of circumferentially spaced pistons, and translator return springs 345, and an actuator support 470 having a plurality of circumferentially spaced cylinders 471 carrying the translators 344 and translator return springs 345 to bias the translators 344 in an axially inboard direction. Pneumatic pressure may be supplied to the pneumatic actuator by the pressurized axle as shown in FIG. 11, or in any other suitable manner to energize the actuation mechanism 310 by pressurizing an interior of the axle itself to save on parts and simplify assembly. Via pneumatic pressure, the pneumatic actuator moves the translator 344 and, thus, the translating member 346 axially by compressing the translators 344. Subsequently, the translating member 346 engages with the indexer 38. Depending upon the relative positions of the indexer 38 and stop or latch member 40, the actuation mechanism 310 moves between an initial or retracted position and a subsequent or extended position. The return members or springs 26 operates to bias or urge the actuation mechanism 310 to the initial or retracted position. Combined with the presently disclosed actuation mechanism 310, air or other gas needs only be applied once to change from one state (e.g. “on”) to another state (e.g. “off”) and vice versa. Of course, a hydraulic actuator may be used instead of a pneumatic actuator, such that any suitable fluid actuator may be used.

The embodiment of FIG. 13 is similar to that of FIG. 12, except that pneumatic pressure may be supplied to a pneumatic actuation mechanism 310′ by a dedicated pneumatic conduit 469 to energize the actuation mechanism 310′. More specifically, the pneumatic actuation mechanism 310′ may include an actuator support 470′ carrying the translators 344, and the conduit 469 having a downstream end coupled to an inlet of the actuator support 470′ that is in fluid communication with the translators 344 to directly compresses the translators 344 instead of via a pressurized interior of the axle itself. The conduit 469 may have an upstream end (not shown) in fluid communication with any suitable source of pneumatic pressure, and any suitable pneumatic pressure controls.

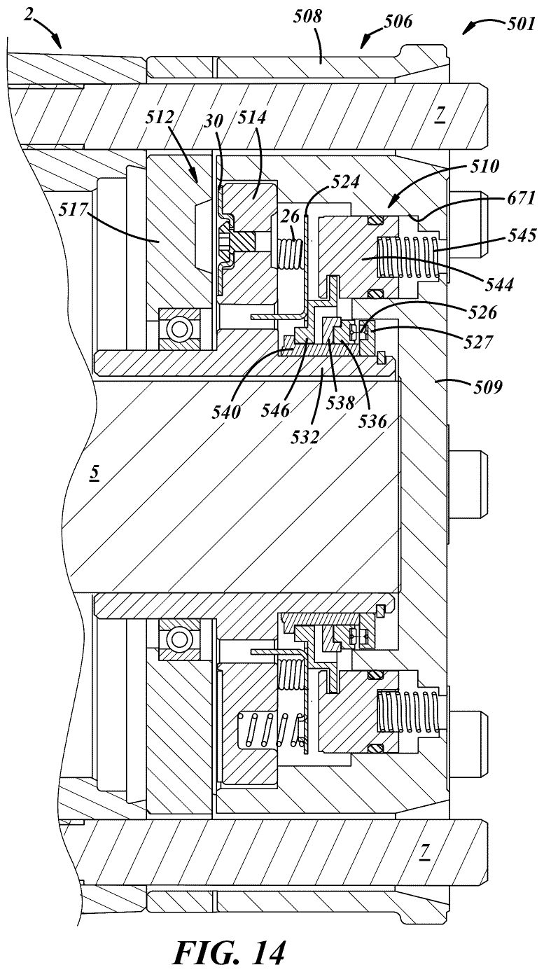

FIG. 14 shows another illustrative embodiment of a wheel end 501 including an embodiment of an integrated pneumatically operated wheel end disconnect mechanism. The position of the actuation mechanism may be flipped 180 degrees from what is shown in FIG. 12. The wheel end 501 includes the axle shaft 5, and a coupling device 512 including a pocket plate 514 coupled to the axle shaft 5 and a notch plate 517 trapped between a wheel hub cover 506 and the wheel hub body 2. The wheel end 501 also includes the actuation mechanism 510 including a plurality of translators 544 carried in translator cylinders 671 in a cover portion 509 of the wheel hub cover 506, a translating member 546 coupled to the translator(s) 544, an indexer 538 cooperative with the translating member 546, a carrier or reaction member 536 cooperative with the indexer 538, a spring reaction member 527, and one or more reaction springs 526 between the spring reaction member 527 and the reaction member 536. The translator cylinders 671 are vented to atmosphere through the wheel hub cover 506 to allow the translators 544 to be compressed in the cylinders 671 against the bias force offered by the springs 545.

Pneumatic pressure may be supplied to the pneumatic actuator, wherein compressed air flows from an axle interior through a spindle, and to the actuation mechanism 510 where it acts on inboard faces of the translators 544 to push the translators 544 into their cylinders 671 to retract the translating member 546 in a direction away from the coupling device 512. Thus, the actuation mechanism 510 moves the spring plate 524 and strut springs linearly away the pocket plate 514 from a clutch “off” position to a clutch “on” position or vice-versa. Depending upon the relative positions of the indexer 538 and spring plate 524, the actuation mechanism 510 moves between an initial or extended position and a subsequent or retracted position. Spring force operates to bias or urge the actuation mechanism to the initial or extended position. In any event, those of ordinary skill in the art would recognize that the actuation mechanisms of the previous “push” style embodiments can be adapted to be effectively reversed for the “pull” style embodiment of FIG. 14.

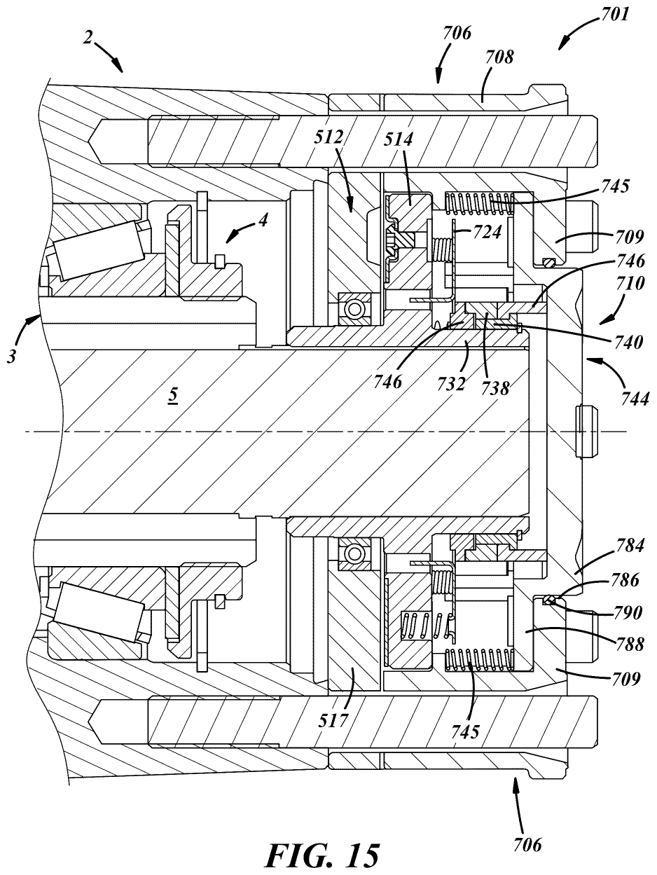

FIG. 15 shows another illustrative embodiment of a wheel end 701 including another embodiment of an integrated manually operated wheel end disconnect mechanism. The wheel end 701 includes the wheel hub body 2, the spindle 3, the axle shaft 5, an actuation mechanism 710, and the coupling device 512 of FIG. 14. The coupling device 512 may include the pocket plate 514 and the notch plate 517. The actuation mechanism 710 may include a translating member 746, an indexer 738, and a manual actuator to move the indexer 738 and the translating member 746. The manual actuator may include a translator 744 in the form of a push button, for example. The translator 744 may have a hub portion 784 that may extend through or be accessible through an opening 786 (for example, a central aperture) of a cover portion 709 of a wheel hub cover 706, and a flange portion 788 that may extend radially outwardly from the hub portion 784 and axially trapped by the cover portion 709 of the wheel hub cover 706. An O-ring 790 or any other suitable seals, bearings, and the like may be disposed between the translator 744 and the cover 706. Also, one or more translator return springs 745 may be interposed between the translator 744 and a corresponding portion of the wheel hub cover 706.

Accordingly, several embodiments of wheel end disconnects have been disclosed as including push-push or recirculating bi-stable mechanisms with pneumatic, electric, and/or manual actuation. Therefore, a wheel hub can be connected to and disconnected from an axle shaft by a bi-stable mechanism, wherein actuation energy is applied momentarily to change a state (on or off) of a wheel end disconnect and need not be persistently applied.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A wheel hub clutch actuation mechanism, comprising:
a hub having a rotational axis;
a latch member rotatably and axially fixed to the hub;
a translating member supported on the latch member, and rotatably fixed and axially movable relative to the rotational axis;
an indexer supported on the hub, and rotatably and axially movable relative to the rotational axis;
a carrier supported on the hub and engaging the indexer, and rotatably fixed and axially movable for axial motion with no rotation; and
a return member biasing the indexer towards a retracted position wherein the translating member acts against the return member to move the indexer to an extended position.

2. A wheel end system, comprising:
a wheel hub including
a wheel hub body having
a hub outboard portion with a hub outboard facing surface having fastener passages therein, and
a spindle passage, and
a wheel hub cover coupled to the hub outboard portion of the wheel hub body;
an axle shaft extending through the spindle passage;
a wheel hub clutch operatively coupled between the axle shaft and the wheel hub cover; and
the wheel hub clutch actuation mechanism of claim 1 cooperative with the wheel hub clutch to engage and disengage the wheel hub clutch to couple and decouple the axle shaft with respect to the wheel hub.

3. The wheel end system of claim 2, wherein the wheel hub clutch includes a pocket plate coupled to the axle shaft and a notch plate unitary with the wheel hub cover, and wherein the actuation mechanism is disposed axially inboard with respect to the pocket plate.

4. The wheel end system of claim 3, further comprising a pneumatic or electric actuator disposed axially inboard with respect to the translating member to move the translating member.

5. The wheel end system of claim 3, further comprising a manual actuator disposed axially outboard with respect to the wheel hub clutch and having a portion accessible via an opening through the wheel hub cover.

6. The wheel end system of claim 2, wherein the wheel hub clutch includes a notch plate, and a pocket plate disposed axially outboard with respect to the notch plate.

7. A vehicle drivetrain having the wheel end system of claim 2.

8. (canceled)

9. (canceled)

10. A wheel hub clutch actuation mechanism, comprising:
a hub including a shaft;
a first member secured to the hub and constrained against rotational and axial movement with respect to the hub, the first member having a first side surface extending between a first inner and a first outer circumferential surface of the first member, the first side surface of the first member including a first cam surface;
a second member rotatably fixed and axially movable with respect to the first member, the second member having a second side surface extending between a second inner and a second outer circumferential surface of the second member, the second side surface of the second member including a second cam surface;
a third member rotatably and axially movable with respect to the shaft, the third member having a third side surface extending between a third inner circumferential surface and a third outer circumferential surface, the third side surface of the third member including a third cam surface and a fourth cam surface, the fourth cam surface of the third member radially inward of the third cam surface of the third member, the third member having a groove in the inner circumferential surface of the third member; and
the first cam surface of the first member is in the groove of the third member when the mechanism is placed in a retracted position, and the first cam surface of the first member contacts the fourth cam surface of the third member when the mechanism is placed in an extended position.

11. A wheel end system, comprising:
a wheel hub including
a wheel hub body having
a hub outboard portion with a hub outboard facing surface having fastener passages therein, and
a spindle passage, and
a hub flange extending transversely outwardly and having wheel fastener passages extending therethrough; and
a wheel hub cover coupled to the hub outboard portion of the wheel hub body;
an axle shaft extending through the spindle passage;
a wheel hub clutch operatively coupled between the axle shaft and the wheel hub cover; and
the wheel hub clutch actuation mechanism of claim 10 cooperative with the wheel hub clutch to engage and disengage the wheel hub clutch to couple and decouple the axle shaft with respect to the wheel hub cover.

12. The wheel end system of claim 11, wherein the wheel hub clutch includes a pocket plate coupled to the axle shaft and a notch plate integrated into the wheel hub cover, and wherein the wheel hub clutch actuation mechanism is disposed axially inboard with respect to the pocket plate.

13. The wheel end system of claim 12, further comprising a pneumatic or electric actuator disposed axially inboard with respect to the second member to move the second member.

14. The wheel end system of claim 12, further comprising a manual actuator disposed axially outboard with respect to the wheel hub clutch and having a portion accessible via an opening through the wheel hub cover.

15. The wheel end system of claim 11, wherein the wheel hub clutch includes a notch plate coupled to the axle shaft and a pocket plate cooperative with the wheel hub cover, and wherein a translator is coupled to the second member and is disposed axially outboard with respect to the pocket plate and has a portion accessible via an opening through the wheel hub cover.

16. A vehicle drivetrain having the wheel end system of claim 11.

17. (canceled)

18. (canceled)

19. A wheel hub clutch actuation mechanism, comprising:
a first member having a first cylindrically shaped body, a first cam surface extending transversely to a first rotational axis of the first member, and an end opposite the first cam surface, the first member including a first plurality of projections and grooves on an outer circumferential surface of the first member;
a second member having a second cylindrically shaped body, a second cam surface extending transversely to a second rotational axis of the second member, and a second plurality of projections and grooves on an a second inner circumferential surface of the second member, the second projections and grooves on the inner circumferential surface of the second member complementary to the first projections and grooves on the outer circumferential surface of the first member wherein engagement of the first projections and grooves on the outer circumferential surface of the first member with the second projections and grooves on the inner circumferential surface of the second member allows axial movement and prevents rotational movement between the first member in the second member;
the second cam surface of the second member spaced radially from and concentric with the first cam surface of the first member;
a third member having a third cylindrically shaped body, a third member cam surface extending transversely to a third rotational axis of the third member, and a third plurality of projections and grooves on a third inner circumferential surface of the third member, the third member cam surface of the third member including a third member first cam surface and a third member second cam surface, wherein third member first and second cam surfaces are concentric; and
the third member first cam surface of the third member engages the second cam surface of the second member, and the third member second cam surface of the third member engages the first cam surface of the first member.

20. A wheel end system, comprising:
a wheel hub including
a wheel hub body having
a hub outboard portion with a hub outboard facing surface having fastener passages therein, and
a spindle passage, and
a hub flange extending transversely outwardly and having wheel fastener passages extending therethrough; and
a wheel hub cover coupled to the hub outboard portion of the wheel hub body;
an axle shaft extending through the spindle passage;
a wheel hub clutch operatively coupled between the axle shaft and the wheel hub cover; and
the wheel hub clutch actuation mechanism of claim 19 cooperative with the wheel hub clutch to engage and disengage the wheel hub clutch to couple and decouple the axle shaft with respect to the wheel hub cover.

21. The wheel end system of claim 20, wherein the wheel hub clutch includes a pocket plate coupled to the axle shaft and a notch plate integrated into the wheel hub cover, and wherein the second member is disposed axially inboard with respect to the pocket plate.

22. The wheel end system of claim 21, further comprising a pneumatic or electric actuator disposed axially inboard with respect to the second member to move the second member.

23. The wheel end system of claim 21, further comprising a manual actuator disposed axially outboard with respect to the wheel hub clutch and having a portion accessible via an opening through the wheel hub cover.

24. The wheel end system of claim 20, wherein the wheel hub clutch includes a notch plate coupled to the axle shaft and a pocket plate cooperative with the wheel hub cover, and wherein a translator is coupled to the second member and is disposed axially outboard with respect to the pocket plate and has a portion accessible via an opening through the wheel hub cover.

25. (canceled)

26. (canceled)

27. (canceled)
